(19) United States
(12) Patent Application Publication
(10) Pub. No.: US 2016/0345539 A1
(43) Pub. Date: Dec. 1, 2016

(54) SYSTEM AND METHOD FOR DETECTING A MEDICAL CONDITION IN A SUBJECT

(71) Applicant: BIOSENSE MEDICAL LTD, Yokneam (IL)

(72) Inventors: Michal MARK-DANIELI, Zur-Moshe (IL); Asher CASTIEL, Even Yehuda (IL)

(21) Appl. No.: 15/115,671

(22) PCT Filed: Jan. 25, 2015
(86) PCT No.: PCT/IL2015/050082

§ 371 Date: Jul. 31, 2016

Related U.S. Application Data
(60) Provisional application No. 61/935,878, filed on Feb. 5, 2014.

(51) Int. Cl. A01K 15/02; A01K 1/03

(52) U.S. Cl. CPC A01K 15/02; A01K 1/031; A01K 15/029

(57) ABSTRACT

A method for training an animal to detect a condition, such as cancer, in a human or animal individual. A training sample is presented to the animal to be trained where, the training sample is a gaseous sample or vapor generated by a cell population associated with the predetermined condition. The population of cells associated with the predetermined condition may be, for example, a culture of an established cell line associated with the predetermined condition. Simultaneously with, or subsequent to, presentation of the training sample, the animal is subjected to an adverse stimulus, such as an electric shock. The animal is allowed animal to perform a first predetermined response in order to avoid, escape or terminate the adverse stimulus. The invention also provides a method for detecting a condition, such as cancer, in an individual in which a trained animal performs the predetermined response upon exposure to vapors from a body fluid of an individual affected with the condition.

### FIELD OF THE INVENTION

The invention relates to methods and systems for training animals to detect an odor, and for using the trained animals to detect the odor.

### BACKGROUND OF THE INVENTION

The following prior art publications are considered to be relevant for an understanding of the background of the invention:
Sponring A, et al. (2009) Release of volatile organic compounds from the lung cancer cell line NCI-H2087 in vitro. Anticancer Res 29: 419-426.
Filipiak W, et al. Release of volatile organic compounds (VOCs) from the lung cancer cell line CALU-1 in vitro Cancer Cell International 2008, 8:17.
Matsumura et al., Urinary Volatile Compounds as Biomarkers for Lung Cancer: A Proof of Principle Study Using Odor Signatures in Mouse Models of Lung Cancer, Published: Jan. 27, 2010.
Dragonieri, S., et al. An electronic nose distinguishes exhaled breath of patients with Malignant Pleural Mesothelioma from controls. Lung Cancer 75 (3): 326-31. J. Lung Cancer, 2011
Filipiak W, et al. Comparative analyses of volatile organic compounds (VOCs) from patients, tumors and transformed cell lines for the validation of lung cancer-derived breath markers. J Breath Res. 2014 June; 8(2):027111.
U.S. Pat. No. 4,022,054 to Biderman.

Cancer is a leading cause of death throughout most of the world. The only treatment that achieves a high rate of cure is surgical resection of early disease (before metastatic spread occurs). Imaging of high risk patients has been used for early diagnosis of cancer. However, while imaging is rather sensitive, it is also relatively non-specific. For example, between 5-26% of high risk smoking patients have detectable lung nodules by CT screening, however only an average of about 4% (with a range of 2-11%) of these nodules are malignant.

Another approach to the early detection of cancer utilizes cancer biomarkers obtained from various body fluids such as sputum, blood and urine. One such class of biomarkers is small molecular weight volatile organic compounds (VOCs) which can be detected as odors by an animal's sense of smell. The lung cancer cell line NCI-H2087 (Sponring et al.) and the human non-small cell lung cancer (NSCLC) cell line CALU-1 (Filipiak W, et al. 2008) have been shown to release specific volatile organic compounds in vitro. Dragonieri, have used an “electronic nose” to capture the spectrum of exhaled VOCs from patients with malignant pleural mesothelioma (MPM) providing a composite biomarker profile (“breathprint”) of the disease. Filipiak W, et al. 2014 observed a significantly higher concentration of ethanol and n-octane, as well as other metabolites released by lung cancer cells in comparison with healthy controls.

Matsumura et al. trained mice to discriminate between odors in urine of mice with and without experimental tumors. Tumors were induced in mice by injecting into the mice the cancer cell line LKR or LLC. LKR is derived from a transgenic animal expressing mutated Kras, and LLC (Lewis lung cell carcinoma) is a tumor that arose spontaneously. Other mice were trained to discriminate between the odors of mouse urine samples collected from the mice with the tumors from the urine of control mice without tumors

U.S. Pat. No. 4,022,054 to Biderman teaches a method and apparatus for training animals to detect a target scent, and for using the trained animals to detect the target scent. The system comprises a cage and means for passing an air current through the cage. The system also includes signal means in the cage operable by a trained animal in the cage in response to detection of the target scent. Using the method and apparatus of the patent, mice were trained to detect explosives.

### SUMMARY OF THE INVENTION

The present invention is based on the novel and unexpected finding that vapors collected from the headspace of tissue cultures can be used to train animals to detect various conditions in an individual from odors generated from a body fluid of a human or animal individual. The inventors have found, for example, that mice trained using such vapors are able to detect various different forms of cancer from vapors collected from the urine of affected individuals.

In one of its aspects, the invention provides a method for preparing gaseous samples for training an animal to detect a predetermined condition in a human or animal individual. The condition may be, for example, cancer. In accordance with this aspect of the invention, a sample for training an animal comprises collecting vapors emitted by a population of cells associated with the predetermined condition. The population of cells associated with the predetermined condition may be, for example, cells obtained from an individual affected with the predetermined condition, or cells derived from one or more cells obtained from an individual affected with the predetermined condition. In particular, the population of cells associated with the predetermined condition may be a tissue culture of cells obtained from an individual affected with the condition or derived from cells obtained from an individual affected with the predetermined condition. The tissue culture may be a culture of an established cell line associated with the predetermined condition.

In another of its aspects, the invention provides samples for training an animal to detect a predetermined condition in a human or animal individual, such as cancer. In accordance with this aspect of the invention, a sample for training an animal to detect a predetermined condition comprises vapors emitted from a population of cells associated with the condition. The population of cells associated with the predetermined condition may be, for example, cells obtained from an individual affected with the predetermined condition, or cells derived from one or more cells obtained from an individual affected with the predetermined condition. In particular, the population of cells associated with the predetermined condition may be a tissue culture of cells obtained from an individual affected with the condition or derived from cells obtained from an individual affected with the predetermined condition. The tissue culture may be a culture of an established cell line associated with the predetermined condition.

In yet another of its aspects, the invention provides a method for training an animal to detect a predetermined condition in a human or animal individual. In accordance with this aspect of the invention, an animal is presented with one or more gaseous training samples released by a cell population associated with the predetermined condition. The animal may be, for example, a rodent such as a mouse or rat, or a dog. Simultaneously with, or subsequent to, presentation of the training samples, the animal is subjected to an adverse stimulus, such as an electric shock, and is trained to perform a first predetermined response in order to terminate, escape or avoid the adverse stimulus. When the animal is presented with gaseous control samples released by a control cell population not associated with the predetermined condition, the animal is not subjected to an adverse stimulus, and the animal does not perform the predetermined first response. The animal, upon presentation with samples from the control population may be trained to perform a second predetermined response or no predetermined response.

The training method of the invention may include a preliminary phase in which the animal is trained to detect a vapor from a synthetic solution containing one or more volatile organic compounds such as dimethyl-2,3-dinitrobutane (DMDNB).

The training method may include a validation phase in which the animal is subjected to a test odor obtained from a body fluid from an individual affected with the predetermined condition to which it was trained. If the animal performs the predetermined first response upon presentation with the test odor, the animal is concluded to be trained to detect the predetermined condition.

The invention also provides an animal trained by the method of the invention. The animal may be, for example, a rodent, such as a mouse or a rat, or a dog.

In yet another of its aspects, the invention provides a method for detecting a predetermined condition in a human or animal individual. In accordance with this aspect of the invention, a mouse trained by the training method of the invention is presented with a test vapor from a body fluid of the individual. The predetermined body fluid may be, for example, urine, blood, or exhaled breath. If, upon presentation with the test vapor, the animal performs the first predetermined response, the individual is concluded to have the predetermined condition.

In still another of its aspects, the invention provides a system for detecting a predetermined condition in an individual. The system of the invention comprises a chamber for confining one or more of the animals. The system of the invention also comprises a device for generating an adverse stimulus to one or more animals in the cage. The system may also comprise one or more response devices that an animal in the cage may utilize when performing the first predetermined response. As an example, the device for generating an adverse stimulus may comprise a grid in the floor of the cage formed from an electrically conducting material that is a component of an electric circuit that can be activated to generate an electric current through the grid. As an example, a device that an animal in the cage utilizes when performing the first predetermined response may be a “safe haven” to which an animal retreats in order to avoid or escape the adverse stimulus. As another example, a device that an animal in the cage utilizes when performing the first predetermined response may be a first lever that the animal depresses in order to avoid, escape or terminate the adverse stimulus. The system may also comprise one or more response devices that an animal in the cage may utilize when performing a second predetermined response, such as a second lever.

The system of the invention further comprises one or more devices for generating an airflow though the chamber. A compressible reservoir serves to contain the gaseous sample. Compression of the compressible reservoir, either manually or by an electronic device, causes injection of the gaseous sample into the airflow through a nozzle or needle. The compressible reservoir may be, for example, a syringe or bellows. The airflow carries the gaseous sample into the chamber where it may be detected by one or more of the animals in the chamber.

Thus, in one of its aspects, the present invention provides a method for training an animal to detect a predetermined condition in a human or animal individual comprising
(a) presenting to an animal a training sample, the training sample being gaseous sample or vapor generated by a cell population associated with the predetermined condition;
(b) simultaneously with, or subsequent to, presentation of the training sample, subjecting the animal to an adverse stimulus;
(c) allowing the animal to perform a first predetermined response in order to avoid, escape or terminate the adverse stimulus; and
(d) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.

Steps (a) to (d) may be repeated any number of times in any order as required. Prior to step (a) a preliminary training procedure may be performed in which the one or more animals are presented with a gaseous sample or vapor obtained from a synthetic preparation of a one or more volatile organic compounds. The one or more volatile organic compounds may include, for example, dimethyl-2,3-dinitrobutane (DMDNB).

The population of cells associated with the predetermined condition may be selected from:
(a) cells obtained from an individual affected with the predetermined condition;
(b) cells derived from one or more cells obtained from an individual affected with the predetermined condition;
(c) a tissue culture of cells obtained from an individual affected with the condition or derived from cells obtained from an individual affected with the predetermined condition′ and
(d) a culture of an established cell line associated with the predetermined condition.

The predetermined condition may be, for example, cancer.

The invention also provides an animal trained by a method to detect a predetermined condition in human or animal individual, the method comprising:
(a) presenting to the animal a training sample, the training sample being gaseous sample or vapor generated by a cell population associated with the predetermined condition;
(b) simultaneously with, or subsequent to, presentation of the training sample, subjecting the animal to an adverse stimulus;
(c) allowing the animal to perform a first predetermined response in order to avoid, escape or terminate the adverse stimulus; and
(d) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.

The animal may be a rodent, such as a mouse, or a dog. The predetermined condition may be, for example, cancer.

The invention further provides a method for detecting a predetermined condition in an a human or animal individual comprising:
(a) providing one or more animals trained by a method to detect the predetermined condition in human or animal individual, the method comprising:
   (i) presenting to the animal a training sample, the training sample being gaseous sample or vapor generated by a cell population associated with the predetermined condition;
   (ii) simultaneously with, or subsequent to, presentation of the training sample, subjecting the animal to an adverse stimulus;
   (iii) allowing the animal to perform a first predetermined response in order to avoid, escape or terminate the adverse stimulus; and
   (iv) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.
(b) presenting the one or more animals with a test vapor from a body fluid of an individual;
(c) if, upon presentation with the test vapor, a predetermined number of the one or more of the animal perform the first predetermined response, concluding that the individual has the predetermined condition;
(d) if, upon presentation with the test vapor, a predetermined number of the one or more of the animal do not perform the first predetermined response, concluding that the individual does not have the predetermined condition.

The predetermined body fluid may be, for example, urine, blood, or exhaled breath. The predetermined condition may be cancer. One or more of the animals may be a rodent, such as a mouse, or a dog. The first predetermined response may be, for example, retreating to a safe haven.

The invention also provides a system for presenting a gaseous sample to one or more animals comprising:
(a) a chamber adapted to confine one or more animals;
(b) a mixing cell;
(c) a device adapted to generate an airflow into the mixing cell and through the chamber;
(d) a device for delivering an adverse stimulus to one or more animals confined to the chamber; and
(e) a safe haven to which one or more animals confined to the chamber can retreat in order to avoid or escape the adverse stimulus; wherein the mixing cell is adapted for injection of the gaseous sample into the mixing cell.

The system may further comprise a device for compressing a compressible reservoir, such as a syringe or bellows, and inject a gaseous or vapor sample in the compressible reservoir into the mixing chamber. The adverse stimulus may be, for example, an electric shock. The safe haven may be, for example, a shelf in the chamber.

The system may further comprise a camera positioned to obtain images of an interior of the chamber and/or a device for determining an identity of each of one or more animals confined to the chamber.

The invention further provides a system for detecting a predetermined condition in a human or animal individual comprising:
(a) a system for presenting a gaseous sample to one or more animals comprising:
   (i) a chamber adapted to confine one or more animals;
   (ii) a mixing cell;
   (iii) a device adapted to generate an airflow into the mixing cell and through the chamber;
   (iv) a device for delivering an adverse stimulus to one or more animals confined to the chamber; and
   (v) a safe haven to which one or more animals confined to the chamber can retreat in order to avoid or escape the adverse stimulus;
   (vi) wherein the mixing cell is adapted for injection of the gaseous sample into the mixing cell; and
(b) one or more animals trained by a method to detect the predetermined condition in a human or animal individual, the method comprising:
   (i) presenting to the animal a training sample, the training sample being gaseous sample or vapor generated by a cell population associated with the predetermined condition;
   (ii) simultaneously with, or subsequent to, presentation of the training sample, subjecting the animal to an adverse stimulus;
   (iii) allowing the animal to perform a first predetermined response in order to avoid, escape or terminate the adverse stimulus; and
   (iv) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.

The predetermined condition may be, for example, cancer.

The invention still further provides a training sample for use in the system of the invention, wherein the population of cells associated with the predetermined condition is selected from:
(a) cells obtained from an individual affected with the predetermined condition;
(b) cells derived from one or more cells obtained from an individual affected with the predetermined condition;
(c) a tissue culture of cells obtained from an individual affected with the condition or derived from cells obtained from an individual affected with the predetermined condition′ and
(d) a culture of an established cell line associated with the predetermined condition.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows a schematic diagram of a system for presenting a gaseous sample to one or more animals, in accordance with one embodiment of the invention.

### DESCRIPTION OF THE INVENTION

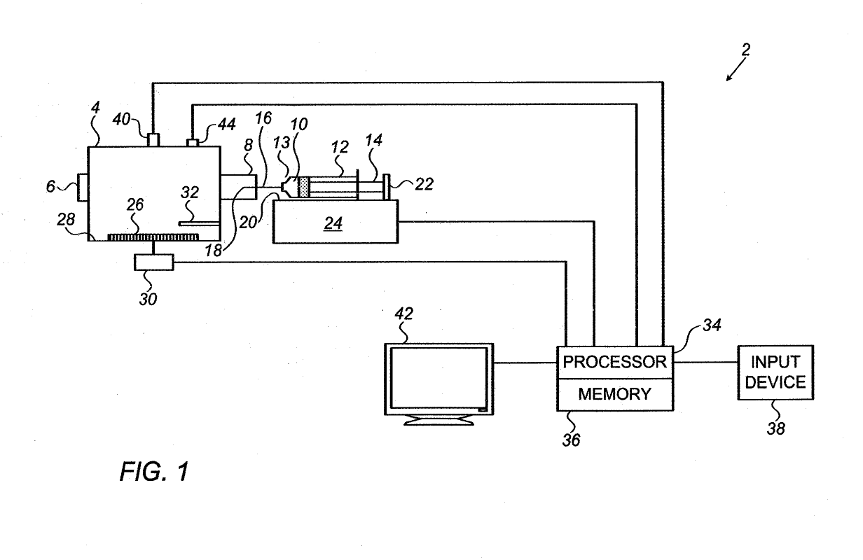

FIG. 1 shows a schematic diagram of a system 2 for presenting a gaseous sample to one or more animals, in accordance with one embodiment of this aspect of the invention. The system 2 comprises a chamber 4 adapted to confine one or more animals. An electric fan 6 generates an airflow of ambient air into a mixing cell 8 and through the chamber 4. The airflow passes through the fan 6 and exits the system 2 as an exhaust through the fan 6.

The mixing cell 8 is adapted to allow a gaseous sample to be injected into the mixing cell 8. A gaseous sample 10 may be loaded into a syringe 12 having a body 13, a plunger 14 and a nozzle or needle 16. The tip 18 of the nozzle or needle 16 is introduced into the interior of the mixing cell 8. Compression of the gaseous sample 10 by depressing the plunger 14 injects the gaseous sample 10 into the mixing cell 8, and is then carried by the airflow into the chamber 4, through the fan 6 and out of the system in the exhaust. Depression of the plunger 14 may be performed manually. A more controlled injection rate may be achieved by mechanical translation of the plunger 14. The body 13 of the syringe 14 may be immobilized on a platform 20 and a pusher 22 under the control of a step motor 24 can translate the plunger 14 (to the left in the perspective of FIG. 1) in order to inject the gaseous sample 10 into the mixing cell 8.

The interior of the chamber 4 is provided with an electric grid 26 covering at least a portion of the floor 28 that is part of an electric circuit 30 that serves to provide an electric shock to an animal in the chamber 4, as explained below. Also in the interior of the chamber 4 is a shelf 32 extending into the interior of the chamber 4 from a wall of the chamber 4 that serves as a “safe haven” to which an animal can retreat in order to avoid or escape an electric shock from the grid 26.

The system 2 further comprises a processor 34 that activates the various components of the system 2 and monitors the functioning of the system 2. For example, the processor may be configured to close a switch in the electrical circuit 28 in order to generate a current in the grid 32. The processor 34 includes a memory 36 that stores data generated by the system. A user input device 38 allows a user to input any user selectable parameters relating to the functioning of the system 2, or relevant data such as the source of the gaseous sample 13, or data relating to animal confined to the chamber 4.

The system 2 may include a camera 40 positioned to obtain images of the interior of the chamber 4 in order to observe the behavior of an animal in the chamber. The interior of the chamber 4 may be illuminated with any type of illumination such as visible light or infrared light. The camera 40 may be a stills camera or a video camera. Images obtained by the camera 40 are input into the processor 40 and stored in the memory 36. Images obtained by the camera 40 may be observed on a screen 42.

The system 2 may also include an RFID transponder 44 that detects an ID signal form an RFID attached to an animal in the chamber 4. The RFID may be attached to the surface of the animal, for example, in the form of a bracelet worn on the leg of an animal, or embedded under the skin of the animal. The ID of an animal in the chamber 4 detected by the transponder 44 is input to the processor 36.

The memory 36 maintains a file for each animal introduced into the chamber 4. An animal's file would typically include data relating to the behavior of the animal in the presence of different gaseous samples 10 when flowing thought the chamber 4. For example, the file may include whether or not the animal retreated to the shelf 32 when presented with a particular gaseous sample.

### Examples

### Materials and Methods

Cell Lines:

The following commercially available cell lines were used. Breast Cancer cell lines: MCF7, T-47D, BT-474, MDA-MB-468, BT-549, MDA-MB-231, MDA-MB-453. Lung Cancer cell lines: NCI-H1299, NCI-H2030, A-549, SHP-77, H1581, and H520. Control (healthy) cell lines: MCF-12A, MCF 10A MRC-9 and ZR-75-1

Tissue Cultures

The cell lines were grown in 175 cm² cell culture flasks in either RPMI 1640 medium or DMEM medium supplemented with 10% fetal bovine serum in an atmosphere containing 5% CO₂. About 2×10⁶ cells were seeded in a flask and the cells were cultured to about 95% confluency (7×10⁶ cells) at which time tissue culture samples were obtained.

Tissue Culture Samples

A silicon connector was attached to each culture flask. The tissue culture samples were obtained by piercing the silicon adaptor using a 60 ml syringe with a 20 G 1.5″ needle and the headspace of the culture was collected into the syringe.

Specimens and Urine Samples

Urine samples were obtained from cancer patients and healthy individuals and immediately frozen (−20° C.) until use. The samples were thawed overnight to 4° C. prior to use, and homogenized. Each urine sample was then transferred to a 175 cm² cell culture flask, a silicon adaptor was attached and the sample heated to 37° C. for 2 hr. The headspace of the urine sample was collected by piercing the silicon adaptor using a 60 ml syringe having a 20 G 1.5″ needle and the headspace was collected into the syringe.

Mice Several groups of mice were trained for detection of lung or breast cancer. Each group contained 5 female mice, strain C57BL/6, purchased from Harlan Laboratories Inc. The mice were housed in individually ventilated cages, in a temperature- and humidity-controlled habitat (Lab Products Inc., USA). The mice were received at the age of two weeks, and started training at the age of one month. Each mouse had a unique RFID tag implanted under its skin for automatic identification.

Training Phase

A system similar to the system 2 shown in FIG. 1 was used to train the mice. Training of the mice to detect a specific target odor was based on avoidance using unconditional stimulation (US). Each mouse was trained individually. A mouse to be trained to detect a specific target odor was confined to the chamber 4 and presented with the target odor by injecting a gaseous sample into the mixing chamber 8 of the system, as explained above. 10 sec after the onset of odor presentation, a 0.17 mA electric current was generated in the grid 26 that was sensed by the mouse as an electric shock, typically in the feet of the mouse. The 0.17 mA current was maintained for 3 sec. In order to avoid the electric shock, the mouse can retreat onto the shelf 32. When a mouse was presented with a control odor, an electric current was not generated in the grid 26. After several episodes of presentation of the target odor and one or more different control odors, the mice learn to retreat onto the shelf 32 when presented with the target odor prior to application of the electric shock in order to avoid the shock. When presented with a control odor, the mice do not retreat onto the shelf.

In a preliminary training procedure, dimethyl-2,3-dinitrobutane (DMDNB, #156345, Sigma Aldrich) served as the target odor which was obtained by collecting the headspace of a container containing DMDNB into 50 ml syringe. A sample of ambient air served as a control odor.

A mouse that reported its target odor at 90% sensitivity (no more than 10% false negatives) and 90% specificity (no more than 10 false positives), stably for 2-3 training sessions, progressed to human sample training in which the target odor was presented as a gaseous sample or vapor obtained by collecting the headspace from cultures of a specific cancer cell line, as explained above. The headspace of unconditioned tissue culture medium, ambient air, and the headspace of non-cancerous cell line cultures were used as control odors. Once the mice learned to discriminate between the target odor from the specific cancer cell line and the control odors samples, odors from additional cancer cell lines were introduced as control odors.

Once the mice learned to report the target odor of the specific cancer at 90% sensitivity and 90% specificity (stably for 2-3 training sessions) the mice progressed to a validation stage in which the mice were exposed to vapors of urine samples obtained from human cancer patients and healthy individuals. At first the mice were exposed to odors from urine samples from one specific cancer patient as the target odor and one specific healthy individual as the control odor. Gradually, additional urine samples from other healthy individuals and other cancer patients with the same form of cancer were introduced as additional control odors. Once the mice learned to report the target odor at 90% sensitivity and 90% specificity (stably for 2-3 training sessions) the mice were considered to be “operational” and suitable for detecting cancer from gaseous samples or vapors obtained from unknown urine samples obtained as above.

Results

Using a system similar to the system 2 shown in FIG. 1, mice trained as above using the various cell lines were presented with urine vapors. For each mouse and each urine specimen, the mouse was presented with vapors from the urine sample on 5 separate occasions. If the mouse jumped onto the shelf in at least 3 of the 5 occasions, the mouse was considered to have identified the sample as containing the target odor to which the mouse was trained.

The results are shown in Table 1. For each target odor and each urine sample, 5 mice trained to detect the target odor were individually tested to determine whether they detected the target odor in a vapor of the urine sample. If at least 3 of the 5 detected the target odor in the urine vapor on at least 3 of 5 separate occasions, a “√” was entered in the corresponding entry of Table 1. Otherwise a “-” was entered in the corresponding entry of Table 1.

The results shown in Table 1 show that mice trained to detect a target odor from a breast cancer or a lung cancer detected the their target odor only in urine vapor from breast cancer patients and lung cancer patients, respectively.

TABLE 1

| | | | Cell Lines Used to Train Mice | | | | | | | | | |
|---|---|---|---|---|---|---|---|---|---|---|---|---|
| | | | Breast Cell lines | | | | | | | | | |
| | | | | | | | Clouding- | | | Lung Cancer | | |
| | | | | | | Basal | low | | HER2 | NSCLC | | |
| | | | Luminal A | | Luminal B | MDA- | | MDA- | MDA- | Adenocarcinoma | | |
| | | | MCF7 | T-27D | BT-474 | MB-468 | BT-549 | MB-231 | MB-453 | NCI- | NCI- | A-549 |
| Source of Urine | NSCLC | Adenocarcinoma | — | — | — | — | — | — | — | √ | √ | √ |
| | | Large | — | — | — | — | — | — | — | √ | √ | √ |
| | | Squamous | — | — | — | — | — | — | — | √ | √ | √ |
| | SCLC | Small | — | — | — | — | — | — | — | √ | √ | √ |
| | Breast Cancer | Luminal A | √ | √ | √ | √ | √ | √ | √ | — | — | — |
| | | Luminal B | √ | √ | √ | √ | √ | √ | √ | — | — | — |
| | | Basal | √ | √ | √ | √ | √ | √ | √ | — | — | — |
| | | Clouding-low | √ | √ | √ | √ | √ | √ | √ | — | — | — |
| | | HER2 | √ | √ | √ | √ | √ | √ | √ | — | — | — |

| | | | Cell Lines Used to Train Mice | | | | | | |
|---|---|---|---|---|---|---|---|---|---|
| | | | Lung Cancer | | | | | | |
| | | | NSCLC | | SCLC | | | | |
| | | | Large | Squamous | Small | Control cell lines | | | |
| | | | H1581 | H520 | SHP-77 | MCR-9 | ZR-751 | MCF-12A | MCF10A |
| Source of Urine | NSCLC | Adenocarcinoma | √ | √ | √ | — | — | — | — |
| | | Large | √ | √ | √ | — | — | — | — |
| | | Squamous | √ | √ | √ | — | — | — | — |
| | SCLC | Small | √ | √ | √ | — | — | — | — |
| | Breast Cancer | Luminal A | — | — | — | — | — | — | — |
| | | Luminal B | — | — | — | — | — | — | — |
| | | Basal | — | — | — | — | — | — | — |
| | | Clouding-low | — | — | — | — | — | — | — |
| | | HER2 | — | — | — | — | — | — | — |

1. A method for training an animal to detect a predetermined condition in a human or animal individual comprising:
(a) presenting to an animal a training sample, the training sample being gaseous sample or vapor generated by a cell population associated with the predetermined condition;
(b) simultaneously with, or subsequent to, presentation of the training sample, subjecting the animal to an adverse stimulus;
(c) allowing the animal to perform a first predetermined response in order to avoid, escape or terminate the adverse stimulus; and
(d) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.

2. The method of claim 1 further comprising repeating steps (a) to (d) a number of times in any order as required.

3. The method according to claim 1 further comprising, prior to step (a) a preliminary training procedure in which the one or more animals are presented with a gaseous sample or vapor obtained from a synthetic preparation of a one or more volatile organic compounds.

4. The method according to claim 3 wherein the one or more volatile organic compounds includes dimethyl-2,3-dinitrobutane (DMDNB).

5. The method according to claim 1 wherein the population of cells associated with the predetermined condition is selected from:
(a) cells obtained from an individual affected with the predetermined condition;
(b) cells derived from one or more cells obtained from an individual affected with the predetermined condition;
(c) a tissue culture of cells obtained from an individual affected with the condition or derived from cells obtained from an individual affected with the predetermined condition, and
(d) a culture of an established cell line associated with the predetermined condition.

6. The method according to claim 1 wherein the predetermined condition is cancer.

7. An animal trained by a method to detect a predetermined condition in human or animal individual, the method comprising:
(a) presenting to the animal a training sample, the training sample being gaseous sample or vapor generated by a cell population associated with the predetermined condition;
(b) simultaneously with, or subsequent to, presentation of the training sample, subjecting the animal to an adverse stimulus;
(c) allowing the animal to perform a first predetermined response in order to avoid, escape or terminate the adverse stimulus; and
(d) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.

8. The animal according to claim 7, wherein the animal is a rodent.

9. The animal according to claim 8 wherein the rodent is a mouse.

10. The animal according to claim 7 wherein the animal is a dog.

11. The animal according to claim 7 wherein the predetermined condition is cancer.

12. A method for detecting a predetermined condition in a human or animal individual comprising:
(a) providing one or more animals trained by a method to detect the predetermined condition in human or animal individual, the method comprising:
(i) presenting to the animal a training sample, the training sample being gaseous sample or vapor generated by a cell population associated with the predetermined condition;
(ii) simultaneously with, or subsequent to, presentation of the training sample, subjecting the animal to an adverse stimulus;
(iii) allowing the animal to perform a first predetermined response in order to avoid, escape or terminate the adverse stimulus; and
(iv) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.
(b) presenting the one or more animals with a test vapor from a body fluid of an individual;
(c) if, upon presentation with the test vapor, a predetermined number of the one or more of the animal perform the first predetermined response, concluding that the individual has the predetermined condition;
(d) if, upon presentation with the test vapor, a predetermined number of the one or more of the animal do not perform the first predetermined response, concluding that the individual does not have the predetermined condition.

13. The method according to claim 12 wherein the predetermined body fluid is selected from urine, blood, or exhaled breath.

14. The method according to claim 12 wherein the predetermined condition is cancer.

15. The method according to claim 12 wherein one or more of the animals is a rodent.

16. The method according to claim 15 wherein the rodent is a mouse.

17. The method according to claim 12 wherein the animal is a dog.

18. The method according to claim 12 wherein the first predetermined response is retreating to a safe haven.

19. (canceled)

20. (canceled)

21. (canceled)

22. (canceled)

23. (canceled)

24. (canceled)

25. A system for detecting a predetermined condition in a human or animal individual comprising:
(a) a system for presenting a gaseous sample to one or more animals comprising:
(i) a chamber adapted to confine one or more animals;
(ii) a mixing cell;
(iii) a device adapted to generate an airflow into the mixing cell and through the chamber;
(iv) a device for delivering an adverse stimulus to one or more animals confined to the chamber; and
(v) a safe haven to which one or more animals confined to the chamber can retreat in order to avoid or escape the adverse stimulus;
(vi) wherein the mixing cell is adapted for injection of to receive the gaseous sample into the mixing cell; and
(b) one or more animals trained by a method to detect the predetermined condition in a human or animal individual, the method comprising:
(i) presenting to the animal a training sample, the training sample being gaseous sample or vapor generated by a cell population associated with the predetermined condition;
(ii) simultaneously with, or subsequent to, presentation of the training sample, subjecting the animal to an adverse stimulus;
(iii) allowing the animal to perform a first predetermined response in order to avoid, escape or terminate the adverse stimulus; and
(iv) optionally presenting to the animal a control sample, the control sample being a gaseous sample or vapor generated by a cell population not associated with the predetermined condition and not subjecting the animal to an adverse stimulus simultaneously with, or subsequent to, presentation of the control sample.

26. (canceled)

27. A training sample for use in the system of claim 25 or 26, wherein the population of cells associated with the predetermined condition is selected from:
(a) cells obtained from an individual affected with the predetermined condition;
(b) cells derived from one or more cells obtained from an individual affected with the predetermined condition;
(c) a tissue culture of cells obtained from an individual affected with the condition or derived from cells obtained from an individual affected with the predetermined condition, and
(d) a culture of an established cell line associated with the predetermined condition.
